(19) United States
(12) Patent Application Publication
(10) Pub. No.: US 2009/0102230 A1
(43) Pub. Date: Apr. 23, 2009

(54) Magic car cover

(76) Inventor: Nathan Bruce Pehrson, Farmington, UT (US)

Correspondence Address: N. Bruce Pehrson, 1106 N Quail Circle, Farmington, UT, 84025, US

(21) Appl. No.: 12/009,789

(22) Filed: Jan. 22, 2008

Related U.S. Application Data
(60) Provisional application No. 60/881,589, filed on Jan. 22, 2007.

(51) Int. Cl. B60J 11/00

(52) U.S. Cl. 296/136.13; 150/166

(57) ABSTRACT

The Magic Car Cover is a utility cover designed to protect the interior of a motor vehicle from harmful infrared solar radiation during hot days. Secondly, it is designed to provide window isolation from ice and snow during winter use. The design is specified to cover only the top-half of a vehicle and in particular covering all windows. This will eliminate the “green house effect” which builds-up temperatures in a transparent or translucent window structure (i.e., unprotected car windows act as a green house). It is further designed to be quickly drawn over the top of a vehicle by a single person. Unique wands, or poles, are used to accomplish a rapid installation. The cover is finally designed to be very light weight using polyester materials and special coatings.

### REFERENCES

1) Provisional Patent Application No. 60/881,589 Dated: Jan. 22, 2007; Confirmation No 1387
2) Utility patent application Ser. No. 12/009,789 Dated Jan. 21, 2008; Confirmation No 6143

### INTRODUCTION

The Magic Car Cover design was initially conceived in 1996 and presented to Steelman Inc., in Las Vegas, Nev. The cover was designed to block solar heating for passenger vehicles, and be very light weight (compared to existing canvas tarpaulins currently in use). No patent was filed at that time. During the succeeding years the design was changed to be more user friendly and have universal seasonal application (focusing on summer and winter). Additionally, the cover was changed to make it very easy and quick to install. This makes the design very unique. Installation is accomplished by using two poles, referred to as “wands,” that is used to pull the cover over the vehicle quickly. The name Magic Car Cover came from the wand use (magic wand). The Magic Car Cover has a set of unique specifications as described in the Specification section of this application.

### MAGIC CAR COVER SPECIFICATIONS

1. Magic Car Cover is a universal utility cover for partially covering a car, truck, SUV, or passenger vehicle from the environment.
2. Cover design is specified for both summer and winter use (see paragraphs 5, 6, and 7 below).
3. Cover design requires the use of super-light weight nylon or polyester material, with a total cover weight of 1 lb.
4. Design is a half-cover design covering the top of a vehicle with the primary function to cover all windows of the vehicle, as identified in paragraph 1 above.
5. Cover is a reversible cover design with a silver side to be used for summer; and black side to be used for winter.
6. Silver coating reflects a minimum of 90% of infrared light from the sun (summer use). The cover uses three layers of silver coating.
7. Black coating absorbs a minimum of 70% of the infrared light from the sun (winter use). The black coating is a special coating.
8. Cover design uniqueness is the use of a wand, or pole structure is installed in the cover and is used to draw the cover over car. This wand is located in the front seam of the cover, and provides for rapid and easy installation.
9. Cover uses two foldable, fiberglass poles in the front and back.
10. A single person is able to install the cover in a very rapid time (i.e., one minute or less).
11. Cover is designed uses a pole structure in the rear of the cover (cover seam) to hold cover in an open position during use. This is to prevent gathering of cover in rear due to elastic tension.
12. Cover uses adjustable elastic side bands to hold cover in place when installed on a vehicle.
13. Additional cover installation retaining is provided with elastics straps and hooks, and by nylon straps with buckles.
14. Cover can withstand 30 mph winds and remain in place on vehicle.
15. Custom designed hooks have been developed for this car cover which attach easily to various designated locations (windshield wiper assembly and side undercarriage or doors.
16. Cover is design is “theft” deterrent. This is accomplished by using nylon straps that are locked in place in the trunk or rear window of vehicle.
17. Cover has been developed to be competitively priced by controlling parts and material, manufacturing, and development.

### BRIEF DESCRIPTION OF THE FIGURES

The accompanying drawings, which are incorporated in and form a part of the Specification, illustrate an embodiment of the present invention and together with the description, serve to explain the concepts of the invention. In the drawings:

FIG. 1 shows a top view of the car cover. The unique collapsible poles are shown at the top and bottom of the cover, and are located in hidden hems. These poles are removable for storage. The cover sides have elastic bands which apply tension to the cover, when installed, and are located in hems.

FIG. 2 shows the detail view of Magic Car Cover as viewed from the top looking down. In this view the components of the cover are indicated as marked. Essentially the car cover consists of: a) light-weight polyester cover; 2) two collapsible fiberglass poles, each with 4 elements; 3) 4 polypropylene or nylon hooks; 4) 2 adjustable buckles; 5) black elastic strapping in the side seams and connected to the 4 hooks; and 6) black nylon strapping for theft deterrence.

FIG. 3 shows the detail of the collapsible poles, or often referred to as the “magic wands.” The two wands have 4 elements each that are made of hollow fiberglass and aluminum hosting sockets that connect the elements together. Elastic strands are located in the poles to hold them together.

FIG. 4 shows the manner in which the car cover fastens to the rear view mirrors. A cut-out is made in the side and is fastening around the rear view mirrors. Elastic straps below the cut-out holds the cover in place.

FIG. 5 shows the detail of the 4 hooks that are used to fasten the cover to the vehicle wiper assembly, or side panels. As no existing off-the-shelf hooks were available that met the requirements for fastening the car cover, then these hooks were designed and fabricated.

FIG. 6 shows the detail of hook design and how it is used to provide and easy adjusting of the elastic straps. This is necessary for allowing variance in vehicle size and hooking locations.

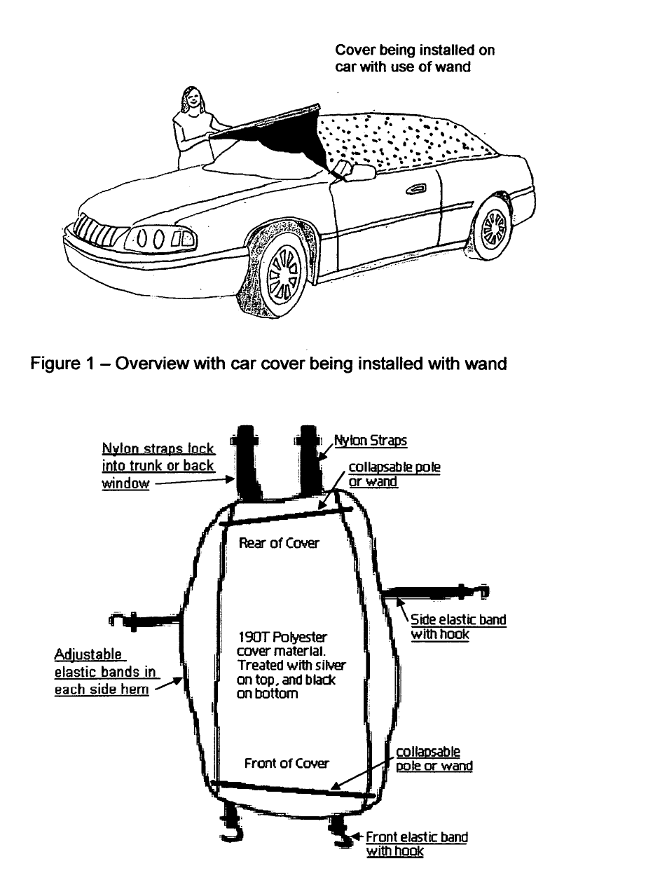

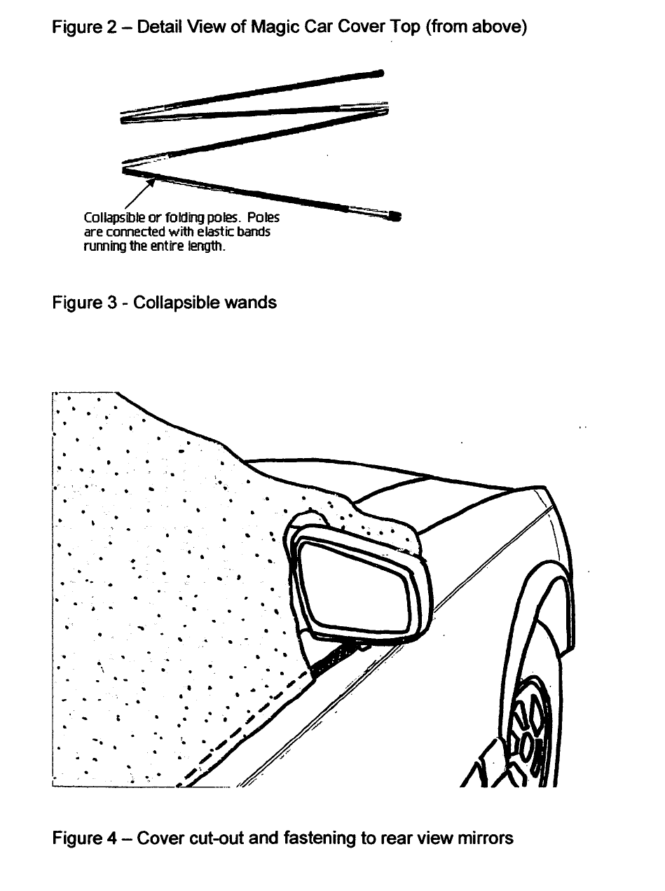

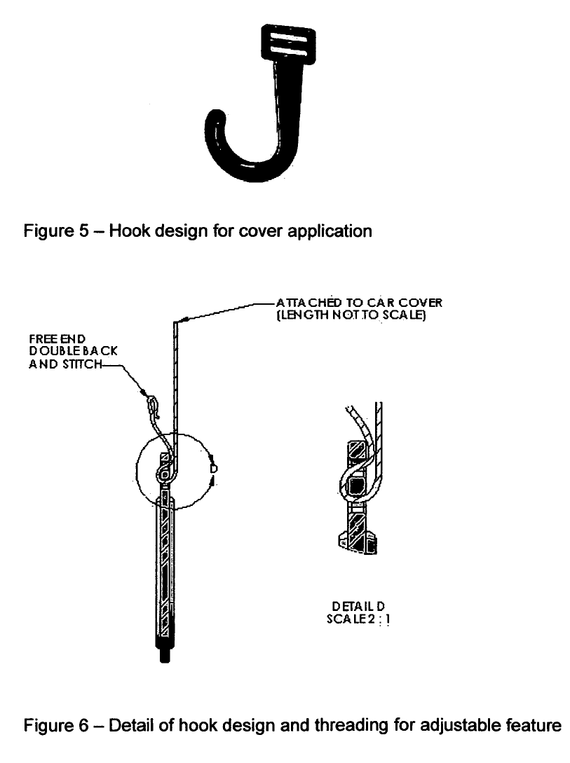

1. I, N. Bruce Pehrson, claim and set forth a multi-purpose, light weight, and rapid-to-install car cover called the Magic Car Cover that uses two light weight poles at each end. What I claim as my invention is specifically a half-car (top half) cover that is drawn over a car using two poles, or wands, for quick installation. An installed cover covers all the glass windows of a car, SUV, Van, or truck. The purpose of the cover is two-fold: one for summer use; and one for winter use. The cover designed uses a very light weight polyester material, and as a result this cover can be stored into a very small duffle, or stuff bag. The car cover designed treated to be water proof thus preventing the material from becoming wet. The cover has one side that is highly solar reflective. This is accomplished by coating the polyester material with a bright silver coating (3 applications). The reverse side is black, and as a result is very solar absorptive during cold winter months. The silver side is for keeping a car cool during the summer months, and the black side is for preventing ice and snow build on the vehicle up during winter months. Due to the wand application, and the rapid speed of installing, the cover is called the Magic Car Cover. I claim that this cover is unique from all other car covers currently designed and on the market. I claim the unique set of Magic Car Cover specifications that follow:
